(19) United States
(12) Patent Application Publication
(10) Pub. No.: US 2013/0024055 A1
(43) Pub. Date: Jan. 24, 2013

(54) ADAPTIVE ENERGY MANAGEMENT IN A HYBRID VEHICLE

(71) Applicants: Gerald J. Hysko, JR., Grand Blanc, MI (US); John W. Ellis, III, Ann Arbor, MI (US); Zachary J. Pieri, Howell, MI (US); Kevin V. Refalo, Milford, MI (US)

(72) Inventors: Gerald J. Hysko, JR., Grand Blanc, MI (US); John W. Ellis, III, Ann Arbor, MI (US); Zachary J. Pieri, Howell, MI (US); Kevin V. Refalo, Milford, MI (US)

(73) Assignee: GM GLOBAL TECHNOLOGY OPERATIONS LLC, Detroit, MI (US)

(21) Appl. No.: 13/184,755

(22) Filed: Jul. 18, 2011

(51) Int. Cl. B60W 20/00

(52) U.S. Cl. 701/22; 180/65.265; 903/930

(57) ABSTRACT

A hybrid vehicle includes an engine, a battery module, a motor, and a controller. The controller commands a target SOC of the battery module and controls the engine or the motor to charge/discharge the battery module based on the target SOC. The controller is configured to record drive information during a drive route and adjust the target SOC during the drive route based at least in part on the drive information recorded. A method includes prompting a user to select a drive route, recording drive information during the drive route, adjusting the target SOC based at least in part on the recorded drive information, and controlling the engine and/or the motor to charge/discharge the battery module during the drive route in accordance with adjusted target SOC.

### TECHNICAL FIELD

The disclosure relates to adaptive energy management in a hybrid powertrain using information from a drive recorder.

### BACKGROUND

Hybrid vehicles may include both an engine and one or more electric motors, each of which provides torque for propelling the vehicle. To extend the driving range of the hybrid vehicle, the motor(s) may operate at times as generators, e.g., during regenerative braking and other regenerative events. Generated electrical energy can then be stored in a high-voltage battery for use in powering the motor(s) or other electrical systems as needed.

### SUMMARY

An example hybrid vehicle as disclosed herein includes a controller which uses recorded drive information parameters in an adaptive manner to optimize fuel economy, as explained in detail below. As is well understood in the art, a hybrid vehicle uses more than one source of energy, such as chemical fuel energy and electrical energy from a high-voltage battery module. The vehicle may include an internal combustion engine which generates engine torque from the combusted fuel. The battery module outputs electrical energy in accordance with its actual state of charge (SOC). An electric motor draws energy from the battery module. The motor converts electrical energy into the mechanical torque needed for electric vehicle (EV) propulsion.

The present controller controls the target SOC of the battery module, and also controls the engine and/or motor to selectively charge or discharge the battery module in accordance with the target SOC. Moreover, the controller records drive information/parameters from the engine and/or the motor during travel over a predetermined drive route and adjusts the target SOC as needed during a future traversing of the same drive route based on the recorded parameters. In this manner, the present approach provides a way of adapting energy management aboard a hybrid vehicle using a hybrid drive recorder.

For instance, by knowing that a specific driver travels a given route to work every day which includes a hill, the controller can deplete the battery module when climbing the hill during the “home-to-work” route and can use the same hill later in the day to recharge the battery module during regeneration during the linked “work-to-home” route. The recorded parameters help inform the controller as to the details of a specific drive route, and allow the controller to adapt or modify the powertrain strategy as needed to better optimize fuel economy. Other examples are provided herein for heavy traffic and highway driving.

An example method includes prompting a user to select a drive route, receiving the selected drive route, determining a target SOC of a high-voltage battery module, and recording parameters from at least one of an engine and an electric motor during the drive route. The method further includes adjusting the target SOC of the battery module based at least in part on the recorded drive information/parameters, and controlling the engine and/or motor to charge or discharge the battery module during the drive route as needed in accordance with adjusted target SOC.

The above features and the advantages of the present disclosure are readily apparent from the following detailed description of the best modes for carrying out the invention when taken in connection with the accompanying drawings.

### BRIEF DESCRIPTION OF THE DRAWINGS

FIG. 1 is a schematic diagram of an example hybrid vehicle having a controller configured to record drive information and adjust a target state of charge of a power source.

FIG. 2 is a schematic diagram of an example user interface that may be used with the vehicle of FIG. 1.

FIG. 3 illustrates an example flowchart that may be implemented by the controller of FIG. 1.

### DETAILED DESCRIPTION

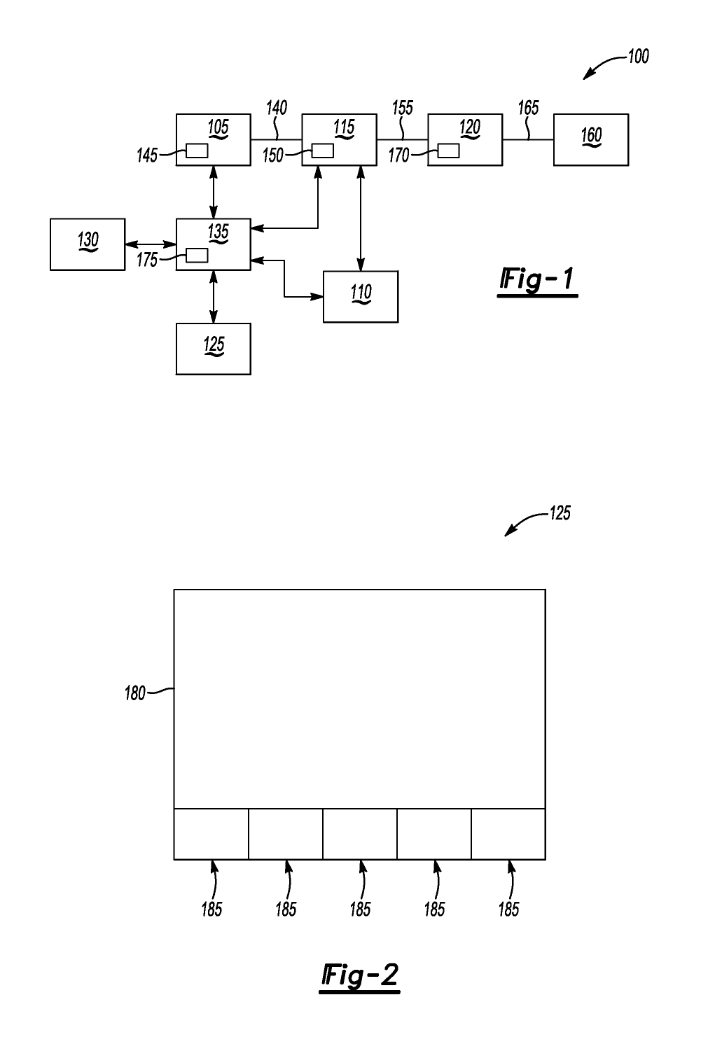

With reference to the drawings, wherein like reference numbers refer to the same or similar components throughout the several views, an example vehicle 100 is shown in FIG. 1. The vehicle 100 includes an engine 105, a power source such as a high-voltage battery module 110, an electric motor-generator unit (MGU) 115, a gearbox 120, a user interface 125, a location sensor 130, and a controller 135. The vehicle 100 may be any passenger or commercial automobile such as a hybrid electric vehicle including a plug-in hybrid electric vehicle (PHEV) or an extended range electric vehicle (EREV), a charge-sustaining hybrid, or the like.

The controller 135 uses recorded parameters to determine characteristics of a drive route, which may provide opportunities for the vehicle 100 to manage energy use more efficiently. Such information may include information about the driver of the vehicle 100, the geographic features, e.g., hills, mountains, turns, etc., that the vehicle 100 has previously encountered during the same drive route, the type of roads such as highways, surface streets, or gravel roads the vehicle 100 has travelled on during the drive route, and the like.

With this or other information, the controller 135 may identify when and where along the same drive route to charge or discharge the battery module 110 so as to maximize fuel economy. Accordingly, the controller 135 may adjust the target state of charge (SOC) of the battery module 110 so that the battery module 110 is at a target SOC at the appropriate time and location of the drive route. The SOC as used herein refers to the amount of electrical energy stored in the battery module 110 relative to its total capacity. The controller 135 may determine the appropriate SOC before, during, or after the drive route, as explained below.

The engine 105 may include any device which generates rotational motion from combusted fuel to produce engine torque. In one possible approach, the engine 105 may be an internal combustion engine configured to combust a mixture of fuel and air in accordance with an Otto cycle, a Diesel cycle, or any other thermodynamic cycle. The engine torque may be output by the engine 105 via a crankshaft 140. The rotational speed or the amount of torque produced by the engine 105 may be controlled by an engine control unit 145.

The battery module 110 may include any device configured to store and/or output electrical energy. For instance, the battery module 110 may include one or more electrochemical cells that are each configured to convert stored chemical energy into electrical energy. In one possible approach, the battery module 110 may be configured to output direct current (DC) energy. An inverter (not shown) may convert the DC electrical energy into alternating current (AC) energy to provide electrical energy to devices used with the vehicle 100 that may operate using AC energy. The inverter may output three-phase AC energy. The battery module 110 may also or alternatively include a rectifier (not shown) to convert AC energy generated by one or more vehicle 100 components into DC energy that may be stored in the battery. Both the inverter and the rectifier may be part of the battery module 110 or may be separate components within the vehicle 100.

The battery module 110 may store and output electrical energy, such as DC energy, in accordance with a state of charge (SOC). Therefore, the SOC may indicate the amount of electrical energy remaining in or available from the battery module 110. The term “actual state of charge” may refer to the amount of electrical energy stored in the battery module 110 at any particular time and the term “nominal state of charge” may refer to a commanded nominal SOC based on, e.g., the current operating mode of the vehicle 100. Accordingly, the battery module 110 may be charged when the actual SOC falls below a nominal SOC or depleted when the actual SOC is above the nominal SOC. As understood in the art, SOC is typically limited to a range above and below the respective fully-depleted/fully-charged levels to maximize battery life.

The motor 115 generates rotational motion or motor torque from electrical energy. To receive the electrical energy, the motor 115 may be in either direct or indirect electrical communication with the battery module 110. That is, the motor 115 may receive either DC energy output by the battery module 110 or AC energy output by the inverter.

The motor 115 may act as a generator. For example, the motor 115 may be selectively coupled to the engine 105 to receive the engine torque and generate electrical energy in accordance with the engine torque received. The motor 115 may be selectively coupled to the engine 105 via a clutch (not shown) that, when engaged, is configured to transfer the engine torque to the motor 115.

Alternatively, the motor 115 may act as a generator during a regenerative braking procedure. That is, as the vehicle 100 is braking, the motor 115 may convert the kinetic energy of the vehicle 100 into electrical energy. The electrical energy generated by the motor 115 may be stored in the battery module 110. In one example implementation, the motor 115 may be configured to generate AC energy that may be converted into DC energy by the rectifier and stored as DC energy in the battery module 110. A motor control unit 150 may control the operation of the motor 115.

The gearbox 120 may include any device configured to convert an input torque into a propulsion torque using one or more gearsets. For instance, the gearbox 120 may be coupled to the engine 105 and/or the motor 115 to receive the engine torque, the motor torque, or a combination of both. The gearbox 120 may receive the torque via an input shaft 155 and output the propulsion torque to wheels 160 of the vehicle 100 via an output shaft 165. The propulsion torque may be a function of the torque received by the input shaft 155 multiplied by a gear ratio. The gear ratio may be based on the physical features of two or more engaged gears within the gearbox 120. A transmission control unit 170 may control the engagement of the gears in the gearbox 120.

The user interface 125 may include any device presenting information and/or queries to a user of the vehicle 100 as well as receive inputs from the user. For example, the user interface 125 may be configured to prompt the user for information, such as to select a predetermined or pre-recorded drive route or to record drive information. The drive route may be programmed into the user interface 125, and the user may select the drive route by selecting among multiple predetermined drive routes presented by the user interface 125. One example user interface 125 is discussed below with reference to FIG. 2.

The location sensor 130 may include any device configured to identify a geographic location of the vehicle 100. The location sensor 130 may further generate a location signal representing the identified geographic location. The location sensor 130 may use any number of satellites, cellular towers, or any other telecommunications landmarks to identify the location of the vehicle 100. Accordingly, in one possible implementation, the location sensor 130 may be implemented in a Global Positioning System (GPS), using On Star®, etc. In other words, the location sensor 130 may incorporate information forecasting the future, e.g., traffic conditions, weather, topography, etc. Such forecasted information may be used by the controller 135 to determine if the driver is driving the selected route. Such information may also be used to prepare the controller 135 for conditions which lie ahead on the route.

The controller 135 may include any device in communication with the battery module 110, the engine 105, the motor 115, the user interface 125, and/or the location sensor 130 that commands the target SOC of the battery module 110 based on the predetermined drive information and the selected drive route. As discussed above, the battery module 110 is selectively charged and discharged in accordance with the target state of charge relative to the actual SOC. The controller 135, therefore, may be configured to charge or discharge the battery module 110 based on real-time driving conditions using the recorded drive information.

The recorded drive information may provide the controller 135 with information about certain characteristics of the drive route that offer opportunities for the vehicle 100 to efficiently recoup and expend electrical energy for storage in the battery module 110. Such information may include information about the driver of the vehicle 100, the geographic features, e.g., hills, mountains, turns, etc., that the vehicle 100 has previously encountered during the drive route, the type of roads such as highways, surface streets, gravel roads, etc., on which the vehicle 100 has travelled during the drive route, the road conditions such as road construction, weather, traffic flow, and the like. With this and/or other information, the controller 135 may identify when and where along the drive route to charge or discharge the battery module 110 to maximize fuel economy. Accordingly, the controller 135 may, e.g., adjust the target SOC in light of the drive information recorded so that the battery module 110 is charged or discharged to avoid over-charging and over-depleting the battery module 110.

In one possible implementation, the controller 135 may be configured to control the engine 105, the motor 115, or any other device in the vehicle 100 to selectively charge or discharge the battery module 110 as needed based on the target SOC relative to the actual SOC. For example, the controller 135 may be configured to control the selective coupling of the engine 105 and the motor 115 by, e.g., coupling the engine 105 to the motor 115 when the actual state of charge falls below the target SOC. When coupled, the motor 115 may receive the engine torque and generate, for instance, AC energy that may be converted to DC energy and stored in the battery module 110.

The controller 135 may also be configured to implement a regenerative braking procedure, as understood in the art, so that the motor 115 can charge the battery module 110 as needed, such as when the actual SOC of the battery module 110 is below the target SOC. As such, the controller 135 may directly or indirectly control the operation of the motor 115 to convert the kinetic energy of the vehicle 100 into electrical energy, such as AC energy, when the vehicle 100 is slowing. Likewise, the controller 135 can discharge the battery module 110 as needed, such as by using an electrical assist mode to drive up a steep hill.

The controller 135 may be in communication with the user interface 125 and may further include or be in communication with a memory device 175 configured to store information in, e.g., a look-up table, database, data repository, or other type of data store. The controller 135 may be configured to receive the selected drive route from the user interface 125, record drive information, and associate the drive information recorded with the selected drive route.

The memory device 175 may be configured to store the recorded drive information and the associated selected drive route. The memory device 175 may further store drive information recorded during previous drive routes. The controller 135 may be configured to access and process the drive information from the memory device 175 and adjust the target SOC before, during, or after the drive in accordance with the parameters stored in the memory device 175.

The controller 135 may be configured to record parameters from any number of sources. For instance, the drive information may include the engine torque, the speed of the engine 105, the motor torque, the speed of the motor 115, etc. Moreover, the controller 135 may be configured to determine a location of the vehicle 100 using, e.g., the location signal generated by the location sensor 130. The controller 135 may be configured to record any combination of one or more of the engine torque, the engine speed, the motor torque, the motor speed, the geographic location, etc., at a plurality of time steps as the drive information.

The controller 135 may further be configured to directly measure the engine torque, the engine speed, the motor torque, the motor speed, etc., using one or more sensors (not shown). Alternatively, the controller 135 may be configured to derive the torque and/or speed of the engine 105 and motor 115 based on control signals. That is, the controller 135 may be configured to receive the control signals generated by the engine control unit 145 and/or the motor control unit 150 and derive the speed and torque of the engine 105 and/or motor 115 from those control signals. In one possible approach, the controller 135 may sample the control signals at a plurality of time steps and derive the torque and/or speed of the engine 105, the motor 115, or both, at each time step.

The controller 135 may also be configured to adjust the target SOC based on other factors besides the operating conditions of the engine 105 and/or the motor 115. For example, the controller 135 may adjust the target SOC based on characteristics of one or more drivers of the vehicle 100. That is, the controller 135 may recognize that different people have different driving styles and, as such, adjust the target state of charge in accordance with a particular driver. The controller 135 may receive the identity of the driver of the vehicle 100 via, e.g., the user interface 125.

Moreover, the controller 135 may be configured to record the drive information based on inputs provided by the user via the user interface 125. Such inputs may include a command to begin or stop recording the drive information, an indication that the driver took a detour so the selected drive route is no longer current, or a command to discard the recorded information if the driver took a different route than selected or if the drive was atypical due to circumstances caused by, e.g., unusual weather or traffic conditions.

In general, computing systems and/or devices, such as the controller 135, the engine control unit 145, the motor control unit 150, the transmission control unit 170, etc., may employ any of a number of computer operating systems and may include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which may constitute a main memory.

Instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above. The controller 135 can utilize the above-described memory, processors, software, etc., anytime there is power to the controller 135.

Referring to FIG. 2, a schematic diagram is shown of an example user interface 125 which may be used in the vehicle 100 of FIG. 1. The user interface 125 as illustrated includes a display device 180 and a plurality of buttons 185.

The display device 180 may include any device configured to electronically display information to the user, who may or may not be the driver of the vehicle 100. In one possible implementation, the display device 180 may be integrated into a dashboard (not shown) of the vehicle 100. The display device 180 may include a liquid crystal display (LCD) device, a light-emitting diode (LED) display device, or the like. The display device 180 may be used to prompt the user to select, e.g., the drive route or provide other information that may be useful to the controller 135 when adjusting the target state of charge. Moreover, the display device 180 may present the user with maps, lists of predetermined or preprogrammed drive routes, or any other information.

The buttons 185 may be virtual buttons presented on the display device 180 or hard buttons on, e.g., a dashboard (not shown) of the vehicle 100. The user may press one or more of the buttons 185 to interact with the user interface 125. For instance, the user may use one or more buttons 185 to select the identity of the driver, select the drive route, or otherwise interact with the controller 135 via the user interface 125. Alternatively, voice command capabilities may be used in conjunction with the buttons 185 or separately when selecting a drive route.

Moreover, the user may use one or more of the buttons 185 to communicate when to start and/or stop recording the drive information, whether the driver has taken a detour or has otherwise deviated from the selected drive route, and whether the user wishes to discard the drive information recorded due to, e.g., atypical circumstances such as unusual weather or traffic conditions. As discussed above, the inputs from the user or driver may be communicated to the controller 135 so that the controller 135 may adjust the target state of charge and control the engine 105, the motor 110, or both, to charge or discharge the battery module 110 using the most reliable recorded drive information.

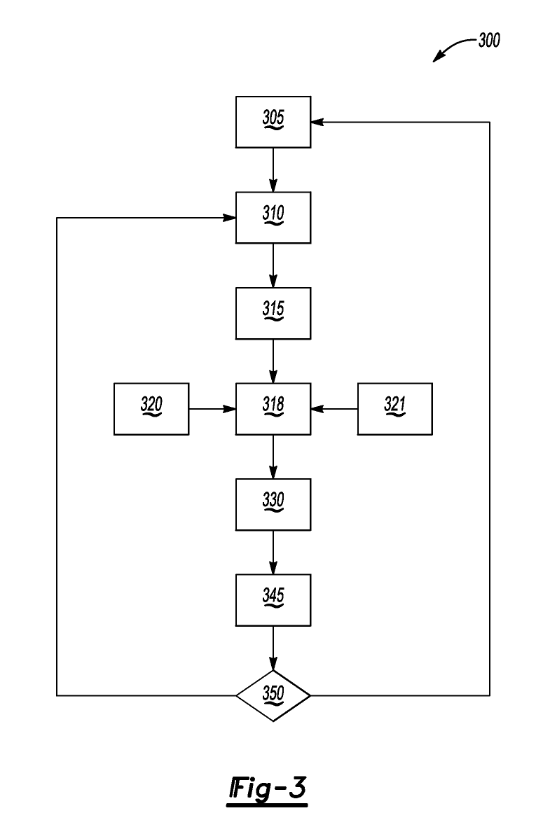

Referring to FIG. 3, a flowchart is shown of an example process 300 which may be implemented aboard the vehicle 100 shown in FIG. 1. Other embodiments are possible which are consistent with the above disclosure.

At block 305, the driver of the vehicle 100 selects a drive route. For instance, the user interface 125 may prompt a user to select a predetermined drive route. The drive route may be selected from a list of preprogrammed drive routes or the user may choose to input a new drive route. In one possible approach, the user may select a destination and the user interface 125 may automatically generate one or more drive routes and prompt the user to select one of the automatically generated drive routes.

At block 310, the controller 135 modifies a target SOC of the battery module 110 based on the route selected at block 305. The controller 135 thus determines what the powertrain is expected to be doing over the selected route. For instance, the target SOC may be modified using the selected drive route given previously recorded drive information stored in the memory device 175 from previous trips along that very same drive route. If no recorded information associated with the selected drive route is stored in the memory device 175, the controller 135 may use a default target SOC. In one possible approach, the controller 135 may modify the target SOC to include a range bound by a minimum target SOC and a maximum target SOC.

At block 315, the controller 135, e.g., a hybrid control processor (HCP), receives the modified target route from block 310 and records the value. Block 315 may entail recording parameters and associating the parameters with various times and locations along the drive route. For instance, the controller 135 may record the engine torque, the engine speed, the motor torque, the motor speed, the geographic location, etc., at a plurality of time steps as the recorded information. The controller 135 can measure some of the drive information using one or more sensors (not shown), or alternatively, derive the torque and/or speed of the motor 115 or the engine 105 from control signals generated by the motor control unit 150 or the engine control unit 145, respectively. The controller 135 may receive the location from, e.g., the location signal generated by the location sensor 130. The controller 135 may store the recorded drive information in the memory device 175.

At block 320, the controller 135 determines the actual SOC of the battery module.

At block 321, the controller 135 checks the calibrated SOC limits of the battery module. As understood in the art, SOC is limited to a max/min range of theoretical maximum capacity, and the SOC is kept to within this range. The values from block 320 and 321 are fed into block 318.

At block 318, the controller 135 compares the actual SOC from block 320 to the hard limits of block 321 and passes the adjusted target SOC from step 310, limited as needed by the hard limits of step 321.

At block 330, the adjusted target SOC from block 310 or the SOC based on the current operating state is passed forward. The controller 135 may revert back to the target SOC which is not based on predetermined route information, or continue forward with the adjusted target SOC based on the selected drive information. This way, the controller 135 may comprehend circumstances during the drive route that are different than previously recorded information.

As discussed above, recorded parameters may provide the controller 135 with information about certain characteristics of the drive route that offer opportunities for the vehicle 100 to better manage the flow of electrical energy. With this and/or other information, the controller 135 may identify when and where along the drive route to charge or discharge the battery module 110 to maximize fuel economy. Accordingly, the controller 135 may, e.g., adjust the target SOC in light of the recorded parameters so that the battery module 110 is charged or discharged at the appropriate time and location given the drive route.

At block 345, the controller 135 determines the present location of the vehicle 100 based on, e.g., the location signal generated by the location sensor 130, e.g., GPS, OnStar®, or other approaches. In this manner, the state of the drive route is determined.

At decision block 350, the controller 135 determines whether the drive route is complete based on the location signal. The controller 135 may, using the geographic location derived from the location signal, determine whether the vehicle 100 has reached its destination. If so, the process 300 may return to block 305 and wait for another drive route selection by the user. If the vehicle 100 has not yet reached its destination, the process 300 may return to block 310. Some blocks may be iteratively executed until the vehicle 100 reaches its destination so, for example, the controller 135 may continually adjust the target state of charge in light of the present geographic location of the vehicle 100 and the recorded drive information.

Using the above process 300, stored information on drive routes, e.g., to and from work, allow the controller 135 to optimally manage energy flow with respect to the battery module 110 and use of fuel energy. The controller 135 may be configured to automatically link a pair of the recorded drive routes each sharing a common route path, i.e., a route to and from work or another destination sharing the same route trace. The controller 135 may be used to control the engine 105 so as to charge the battery module 110 during one of the pair of recorded drive routes, and to control the electric motor 115 to discharge the battery module 110 during the other of the pair of recorded drive routes.

As an illustrative example, if one drives on a highway for 20 miles each day, the battery module 110 could be utilized more to reduce engine load and improve fuel economy. This could be done efficiently and effectively since the vehicle 100 would be coming off the exit ramp. That is, the controller 135 can lower the SOC charge target in anticipation of regeneration occurring at the ramp.

In a city example, the same driver may be idle in traffic for a large part of the commute. The engine 105 could be used to charge the battery module 110 to a higher than typical SOC. Once charged, the engine 105 could remain off instead of cycling on and off frequently while sitting in stop and go traffic. EV operation is thus extended beyond its typical use.

In an example hill climb mode, the driver drives vehicle 100 up a grade while commuting to work, and down the same grade while commuting home from work. In this instance, driver information can be linked together for the two routes (to and from work) such that the benefits of traveling back down the hill can be realized while going up the hill. That is, speed and load data may be used to allow a more aggressive SOC depletion during hill ascent in anticipation of extended regeneration during descent of the same hill.

While the best modes for carrying out the invention have been described in detail, those familiar with the art to which this invention relates will recognize various alternative designs and embodiments for practicing the invention within the scope of the appended claims.

1. A hybrid vehicle comprising:
an engine configured to generate an engine torque;
a battery module configured to store and output electrical energy in accordance with an actual state of charge (SOC);
an electric motor in electrical communication with the battery module, and configured to generate a motor torque based at least in part on the electrical energy received from the battery module, wherein the motor is further configured to generate electrical energy; and
a controller in communication with the engine, the battery module, and the motor, wherein the controller is configured to:
record a drive route;
command a target SOC of the battery module in response to the drive route;
control at least one of the engine and the motor to charge or discharge the battery module as needed in accordance with the target SOC;
record drive information from at least one of the engine and the motor during a current drive route;
compare the current drive route to the recorded drive route; and
adjust the target SOC during the current drive route based at least in part on the recorded drive information when the current drive route is the recorded drive route.

2. A hybrid vehicle as set forth in claim 1, wherein the controller is configured to automatically link a pair of the recorded drive routes each sharing a common route path, controlling the engine to charge the battery during one of the pair of recorded drive routes, and controlling the motor to discharge the battery module during the other of the pair of recorded drive routes.

3. A hybrid vehicle as set forth in claim 1, wherein the controller is configured to control the motor during a regenerative braking procedure to generate electrical energy to charge the battery module if the actual SOC is below the target SOC.

4. A hybrid vehicle as set forth in claim 1, further comprising a user interface in communication with the controller and configured to receive at least one input from a user.

5. A hybrid vehicle as set forth in claim 4, wherein the user interface is configured to prompt the user to select the drive route, and wherein the controller is configured to receive the selected drive route from the user interface.

6. A hybrid vehicle as set forth in claim 5, further comprising:
a memory device in communication with the controller and configured to store the recorded drive information associated with the selected drive route;
wherein the controller is configured to access the recorded drive information from the memory device whenever power is provided to the controller.

7. A hybrid vehicle as set forth in claim 1, wherein the controller calculates the adjusted target SOC using, as the drive information and at a plurality of time steps, at least one of: the engine torque, the motor torque, speed of the engine, speed of the motor, an actual SOC of the battery module, and speed of the vehicle.

8. A hybrid vehicle as set forth in claim 7, wherein the controller uses, as the drive information, each of the engine torque, the motor torque, the speed of the engine, the speed of the motor, and the speed of the vehicle, at a plurality of time steps to calculate the adjusted target SOC.

9. A hybrid vehicle as set forth in claim 1, further comprising:
an engine control unit in communication with the controller and configured to generate control signals to control at least one of the engine torque and a speed of the engine;
wherein the controller is configured to receive one or more of the control signals generated by the engine control unit and record at least one of the engine torque and the speed of the engine at a plurality of time steps during the drive route based at least in part on the control signals received.

10. A hybrid vehicle as set forth in claim 1, further comprising:
a motor control unit in communication with the controller and configured to generate control signals to control at least one of the motor torque and a speed of the motor;
wherein the controller is configured to receive one or more of the control signals generated by the motor control unit and record at least one of the motor torque and the speed of the motor during the drive route at a plurality of time steps based at least in part on the control signals received.

11. A hybrid vehicle as set forth in claim 1, further comprising:
a location sensor in communication with the controller and configured to identify a geographic location and generate a position signal representing the identified geographic location;
wherein the controller is configured to receive the position signal and record the location during the drive route at a plurality of time steps based at least in part on the position signal.

12. A method comprising:
prompting a user to select a drive route;
receiving the selected drive route;
determining a target state of charge (SOC) of a battery module;
recording drive information from at least one of an engine and a motor during the drive route;
adjusting the target SOC of the battery module based at least in part on the recorded drive information; and
controlling at least one of the engine and the motor to charge the battery module during the drive route in accordance with adjusted target SOC.

13. A method as set forth in claim 12, further comprising automatically linking a pair of the recorded drive routes each sharing a common route path, controlling the engine to charge the battery during one of the pair of recorded drive routes, and controlling the motor to discharge the battery module during the other of the pair of recorded drive routes.

14. A method as set forth in claim 12, wherein recording the drive information includes recording, at a plurality of time steps, at least one of: an engine torque, a motor torque, a speed of the vehicle, a speed of the engine, and a speed of the motor.

15. A method as set forth in claim 12, wherein recording the drive information includes recording each of the engine torque, the motor torque, the speed of the vehicle, the speed of the engine, and the speed of the motor.

16. A method as set forth in claim 12, wherein recording the drive information includes:
deriving a torque or speed of at least one of the engine and the motor from a control signal;
recording the derived torque or speed of at least one of the engine and the motor during the drive route.

17. A method as set forth in claim 12, wherein recording the drive information includes recording a geographic location at a plurality of time steps during the drive route.

18. A method as set forth in claim 12, further comprising:
comparing an actual SOC to the adjusted target SOC;
wherein controlling at least one of the engine and the motor to charge the battery module includes controlling at least one of the engine and the motor to charge the battery module if the actual SOC is below the target SOC.

19. A hybrid vehicle comprising:
a user interface configured to receive, via a user, a selected drive route;
a location sensor configured to identify a geographic location and generate a location signal representing the geographic location identified;
a battery module configured to store and output electrical energy in accordance with an actual state of charge (SOC);
an engine configured to generate an engine torque;
a motor in electrical communication with the battery module and configured to generate a motor torque based at least in part on the electrical energy received from the battery module, wherein the motor is further configured to generate electrical energy; and
a controller in communication with the user interface, the location sensor, the power source, the engine, and the motor, and wherein the controller is configured to:
receive the selected drive route from the user interface;
command a target SOC of the battery module based at least in part on the selected drive route;
record drive information from at least one of the location sensor, the engine, and the motor during the selected drive route;
adjust the target SOC based at least in part on the recorded drive information recorded; and
control at least one of the engine and the motor to selectively charge or discharge the battery module as needed during the drive route in accordance with the adjusted target SOC.
